(19) United States
(12) Patent Application Publication
(10) Pub. No.: US 2007/0207282 A1
(43) Pub. Date: Sep. 6, 2007

(54) Polylactic Acid Gloves and Methods of Manufacturing Same

(76) Inventor: Curtis P. Hamann, Paradise Valley, AZ (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/680,041

(22) Filed: Feb. 28, 2007

Related U.S. Application Data
(60) Provisional application No. 60/777,883, filed on Mar. 1, 2006.

(51) Int. Cl. B32B 27/32

(52) U.S. Cl. 428/35.2

(57) ABSTRACT

Biodegradable disposable gloves and methods of manufacturing the same are disclosed in which the elastomeric material used to manufacture the gloves includes a polylacetic acid polymer component in combination with a biodegradable plasticizer. The present invention provides a biodegradable disposable glove that can be manufactured utilizing substantially the same process as nonbiodegradable gloves, lending to the particular utility of the present invention.

### CROSS-REFERENCE TO RELATED APPLICATION

This application claims priority of U.S. Provisional Patent Application No. 60/777,883, which is entitled “Polylacetic Acid Gloves and Methods of Manufacturing the Same,” and which was filed on Mar. 1, 2006, the entirety of which application is hereby incorporated herein by reference.

### BACKGROUND OF THE INVENTION

### Field of the Invention

The present invention relates generally to disposable gloves. More particularly, the present invention relates to biodegradable disposable gloves constructed of polylacetic acid and methods of making the same.

Disposable gloves are widely used by members of the medical community, the scientific community, and the industrial community to protect the wearer from chemical exposure, mechanical abrasion, environmental hazards, and biohazard contamination, and to prevent transmission of disease or contaminants. Health care providers frequently wear disposable gloves while performing surgery or other medical or dental procedures such as patient examinations; thus, the gloves are often also referred to as disposable examination gloves or disposable surgical gloves. The disposable gloves are impermeable to biological fluids, tissues, and solids produced by the body or other contaminants (human or animal), advantageously protecting the wearer from fomitic (transmission by objects that harbor pathogenic organisms) transmission of pathogens and disease.

Also, disposable gloves are worn by individuals who wish to protect their hands from various chemicals, materials, and objects which may irritate, damage or dry out the user's skin and which may be harmful or potentially harmful if allowed to contact or permeate the dermal barrier. These gloves may be worn in the occupational setting by scientists, cleaning service workers, food handlers, law enforcement workers, beauticians or other workers having special protection needs. Thus, disposable gloves may also be referred to as protective gloves, food handling gloves or industrial gloves.

As is known in the art, disposable gloves are thin and flexible and are typically manufactured from a variety of polymeric materials/resins herein throughout referred to as “elastomer(s)” or “elastomeric material(s)” or “elastomeric blend(s)”.

The types of elastomers typically utilized in the manufacture of disposable gloves include materials such as synthetic rubber or plastic. Examples of such materials can include, but are not limited to, synthetic polyisoprene, a chloroprene (including Neoprene-homopolymer of the conjugated diene chloroprene), a polyurethane (“PU”), a polyvinyl chloride (“PVC”), a styrene butadiene styrene (“SBS”), a styrene isoprene styrene (“SIS”), a silicone, a butadiene methylmethacrylate, an acrylonitrile, a styrene ethylene butylene styrene (“SEBS”), and/or acrylate-based hydrogels. Regardless of the type of end use application and/or specific thermoplastic used, elastomeric gloves are typically thrown away after a single use, and therefore, a significant amount of waste is generated.

Importantly, many of the polymers utilized in manufacturing disposable gloves are petroleum based and resist environmental degradation. Indeed, the environmental impact of nonbiodegradable plastic waste is a growing concern and alternative disposal methods for such plastics are limited. For example, incineration of synthetic plastics generates toxic emissions and satisfactory landfill sites are becoming increasing limited.

Further, petroleum resources are finite. Indeed, as petroleum reserves decrease in abundance, the raw material and production costs associated with the manufacture of such nonbiodegradable, thermoplastic gloves will increase accordingly. In addition, government regulations may increase disposal and recycling costs for nonbiodegradable plastics to accommodate landfilling and/or environmental impact resulting from use of such materials.

Fully biodegradable polymers have been commercially available for a number of years. Among these polymers, polylacetic acid has been extensively studied in medical implants, suture, and drug delivery systems due to its biodegradability and has been approved for use in various medical devices. As is well known to those skilled in the art, polylacetic acid polymers have physical properties that compare to petroleum-based synthetic polymers, rendering them useful over other biodegradable polymers.

Polylacetic acid can be made from lacetic acid (lactate). Lacetic acid is a natural molecule that is widely employed in foods as a preservative and a flavoring agent. It is the main building block in the chemical synthesis of the polylactide family of polymers. Although it can be synthesized chemically, lacetic acid is procured principally by microbial fermentation of sugars such as glucose or hexose. These sugar feed stocks can be derived from potato skins, corn, wheat, and dairy wastes. The lacetic acid monomers produced by fermentation are then used to prepare polylactide polymers.

Lacetic acid exists essentially in two stereoisomeric forms, which give rise to several morphologically distinct polymers: D-polylacetic acid, L-polylacetic acid, D,L-polylacetic acid, meso-polylacetic acids, and any combinations of thereof. D-polylacetic acid and L-polylacetic acid are stereoregular polymers. D,L-polylacetic acid is a racemic polymer obtained from a mixture of D- and L-lacetic acid, and meso-polylacetic acid can be obtained from D,L-lactide. The polymers obtained from the optically active D and L monomers are semicrystalline materials, but the optically inactive D,L-polylacetic acid is substantially amorphous.

Degradation of PLA occurs in two stages. First, the ester groups are gradually hydrolyzed by water to form lacetic acid and other small molecules, and then these products are decomposed by microorganisms in the environment. In addition, disposal of PLA products is easier than that of traditional polymers, because polylacetic acid incinerates cleanly with lower energy yield, thereby permitting a higher incinerator facility throughput. Further, PLA contains no chlorine or aromatic groups, so PLA burns much like paper, cellulose, and/or carbohydrates—generating few combustion by-products.

In addition, polylacetic acid polymers can be manufactured from renewable resources, unlike conventional, synthetic petroleum-based polymers—since the lactate from which it is ultimately produced can be derived from the fermentation of agricultural by-products such as corn starch or other starch-rich, substances like maize, sugar or wheat.

Biodegradable disposable gloves are only very generally known in the art; however, none of the gloves heretofore known have been constructed of a polylacetic acid polymer. In particular, PLA is more expensive than many petroleum-derived commodity plastics, and, as such, use of PLA for disposable medical and/or inductrial gloves is cost prohibitive—especially given the sheer number of disposable gloves utilized, for instance, in hospitals and clinics. Further, carcinogenicity and toxicity concerns related to the use of certain plasticizers have previously taught against use of PLA polymers in the production of disposable medical gloves.

U.S. Pat. No. 6,393,614 to Eichelbaum discloses a disposable, loose-fitting glove with pockets for carrying an item such as a tampon or sanitary napkin from a patient. While the glove is recited to be biodegradable in theory, no material of construction or degradability specifications are disclosed or suggested. Indeed, the '614 patent does not enable or provide a description of the biodegradable materials or methods of construction/manufacturing considered within the scope of the invention.

Accordingly, there is a need for disposable gloves constructed of a biodegradable elastomeric material, as an alternative to conventional, nonbiodegradable glove materials—to reduce the amount of waste associated with use of disposable gloves and/or to reduce the dependency on petroleum based gloves. In particular, there is a need for biodegradable gloves that meet the durability requirements, industry guidelines, and/or federal food and drug safety requirements associated with their intended end-use applications. It is a further objective of the present invention to provide biodegradable gloves that have the feel, stretch, and sensitivity of conventional, nonbiodegradable thermoplastic gloves.

Accordingly, it is a primary objective of the present invention to provide biodegradable, disposable gloves manufactured of a polylactide polymer. It is a related objective of the present invention to provide disposable gloves for use in a wide variety of applications, including but not limited to healthcare, food handling, cosmetic, biomedical, electrical, and/or cleanroom applications, wherein the disposable gloves are constructed of polylacetic acid alone or in combination with other biodegradable elastomeric materials. The resulting glove being at least partially biodegradable and/or meeting the biodegradability requirements established by a particular industry, government authority, and/or environmental agency.

In addition, while disposable gloves can also be manufactured of natural latex rubber, which may be at least in part biodegradable, issues with latex allergies is a significant issue for some users; rendering the need for a non-latex, biodegradable disposable gloves essential in the art.

Accordingly, it is a further objective of the present invention to provide disposable gloves manufactured from polylacetic acid and/or a polymeric blend including a polylacetic acid component—the amount of polylacetic acid component within the elastomeric matrix of the glove varying depending upon desired performance properties or end-use application, including such factors as the particular chemical permeability and/or sensitivity properties required by the application, the environmental stability required and/or required degradation rate required (i.e. oxidative stability, ozone, UV, temperature, and humidity) and/or the physical properties (tear and/or puncture strength) required. In particular, the polylactide gloves of the present invention can be constructed to meet relevant ASTM Standards for biodegradability and/or compostability.

A preferred polylactide disposable glove constructed in accordance with the present invention can be manufactured without requiring substantial modification to existing manufacturing methods for such articles. Also, the polylactide, disposable gloves of the present invention should retain all of the desirable functional characteristics of disposable gloves constructed of conventional, nonbiodegradable elastomeric materials.

### SUMMARY OF THE INVENTION

The disadvantages and limitations of the background art discussed above are overcome by the present invention. With this invention, biodegradable disposable gloves constructed of polylactide and methods for making the same are disclosed. The present invention includes gloves for use in a wide number of medical and/or industrial applications and is not limited to any one particular application.

For the purposes of the present application, the term “biodegradable” and/or “biodegradability” refers to a degradable plastic in which degradation results from the action of naturally occurring microorganisms such as bacteria, fungi, and/or algae. “Degradation” refers to an irreversible process leading to a significant change of the structure of a material, typically characterized by a loss of properties (e.g. integrity, molecular weight, structure or mechanical strength) and/or fragmentation. Degradation can be affected by environmental conditions, such as exposure to ozone, ultraviolet light, extreme temperatures, and/or humidity, and proceeds over a period of time.

Accordingly, the biodegradable gloves of the present invention can be designed to comply with any biodegradability and/or compostability standards/requirements established by a particular government agency and/or industry, such as, for example, relevant ASTM or ISO standards. As such, the present invention is not limited to any one specific biodegradability standard and/or degradation rate for biodegradability—and is a matter of design choice. Indeed, the present invention can include gloves designed to degrade at certain degradation rate required by a given standard or regulation and/or gloves that merely degrade at a rate faster than a conventional non biodegradable glove.

Accordingly, in part, the biodegradable gloves of the present invention can be constructed of one or more layers of an elastomeric material including a polylacetic acid polymer component. The polylacetic acid polymer component preferably comprises from about 1% to about 100% L-lactide monomer, with the remaining monomer selected from, but not limited to, D-lactide, meso D,L lactide, D,L lactide monomers, and combinations thereof.

However, consistent with the broader aspects of the present invention, the polylacetic acid polymer component can be any homopolymer of lacetic acid and/or a block, graft, random, and/or copolymer of lacetic acid, including, D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid, depending on the given end-use application of the gloves and/or the specified/required rate of biodegradability.

The disposable gloves of the present invention further includes one or more biodegradable plasticizer. The biodegradable plasticizer is provided within the polylactide elastomeric matrix used to construct the one or more of the layers of the biodegradable glove. Such plasticizer components preferably include, but are not limited to, citric acid esters, such as, triethyl citrate, acetyl triethyl citrate, and/or acetyl tributyl citrate. Where required, the disposable gloves of the present invention can include additional plasticizers capable of plasticizing PLA (e.g. nontoxic, nonbiodegradable, and/or only substantially biodegradable plasticizers may be used.)

As is well known to those skilled in the art, plasticizers are compounds that are incorporated into disposable materials of the present invention during, or after, polymerization. Introduction of plasticizers into the polylactide polymer can reduce the melt viscosity of the polymer and lower the temperature, pressure, and shear rate required to form the polymer. Plasticizers introduce pliability, flexibility, and toughness into a polymer to an extent not typically found in a material containing only a polymer or copolymer—as such, plasticizers can also affect the degradation rate of the glove.

Accordingly, the polylacetic acid polymer, the ratio and/or types of lactide monomers utilized therein, and the biodegradable plasticizer are provided in a quantity sufficient to maintain or to not fall outside the physical requirements of the ASTM and ISO standards for the particular type of glove manufactured (such as, but not limited to all physical requirement tables, ASTM D 3577-01a^{•2}—Table 3, ASTM D 5250-00^{•4}—Table 3, ASTM D 6319-00a^{•3}—Table 3, ISO 11193:1994(E)—Table 3, ISO 10282: 1994(E)—Table 3, ASTM D 3578-01a^{•2}—Table 1, and ASTM D 4679-02—Table 3).

In certain other preferred embodiments, the biodegradable gloves of the present invention can be constructed of more than one layer of elastomeric material including a polylacetic acid polymer and a biodegradable plasticizer, with each layer of the glove being designed to comply with specific requirements for a given end-use application—wherein each layer is designed to have substantially similar or substantially different physical properties (permeability, tear strength, and/or puncture strength), degradation rates, and/or environmental sensitivity properties (i.e. oxidative stability, ozone, UV, temperature, and humidity).

Further, one or more of the layers of the polylacetic acid glove of the present invention can include additional components/additives incorporated into the elastomeric material from which the glove is made and/or have additional components coated on one or more surfaces of the glove. For example, a flavoring component, a therapeutic component and/or a botanical component may be included in the elastomeric material from which the glove is made.

Further, in certain other embodiments, the present invention includes a biodegradable, disposable constructed of a biodegradable polymer component comprising substantially a polylacetic acid resin in combination with one or more other biodegradable materials/resins, including but not limited to starch or an aliphatic polyester.

It may therefore be seen that the present invention provides a fully and/or substantially biodegradable disposable glove to reduce the amount of waste associated with use of disposable gloves and/or to reduce the dependency on petroleum based gloves. In particular, the present invention provides biodegradable gloves that meet the durability requirements and/or industry guidelines associated with a particular end-use application, having the feel, stretch, and sensitivity of conventional, nonbiodegradable thermoplastic gloves.

Thus, it may also be seen that the present invention provides a biodegradable, polylactide-based disposable glove for use in a wide variety of applications, including but not limited to healthcare, food handling, cosmetic, biomedical, electrical, and/or cleanroom applications, wherein the disposable gloves are constructed of polylacetic acid alone or in combination with other biodegradable elastomeric materials.

Thus, it may also be seen that the present invention provides a method for manufacturing biodegradable, polylactide-based disposable gloves including providing a polylacetic acid based elastomeric matrix and forming a disposable glove from the polylacetic acid based elastomeric material.

Other advantages and features of the invention, together with the organization and manner of operation thereof, will become apparent from the following detailed description when taken in conjunction with the accompanying drawings. It is expressly understood that the drawings are for the purpose of illustration and description only, and are not intended as a definition of the limits of the invention.

The biodegradable gloves of the present invention are of a construction which is both durable and long lasting, and which will require little or no maintenance to be provided by the user throughout its operating lifetime. The biodegradable gloves of the present invention are also of inexpensive construction to enhance their market appeal and to thereby afford them the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is a perspective view of a glove showing an outer surface thereof and an inner or wearer-contacting surface thereof;

FIG. 2 is a cross sectional view of a portion of a single layer glove constructed of a polylactide polymer;

FIG. 3 is a cross sectional view of a portion of a bilaminar layer glove having two layers constructed of a polylactide polymer;

FIG. 4 is a cross sectional view of a portion of a single layer glove constructed of a biodegradable polymer including at least in part a polylactide polymer component;

FIG. 5 is a schematic flow diagram showing a dipping process for making a glove of the present invention; and

FIG. 6 is a schematic flow diagram showing a method of making a glove of the present invention.

### DETAILED DESCRIPTION OF THE PREFERRED EMBODIMENT

This invention relates to biodegradable disposable gloves constructed at least in part of a polylacetic acid polymer material and methods for making the same. As will be readily appreciated by those skilled in the art, other dipped elastomeric articles, such as condoms, may be included within the broader aspects of the present invention.

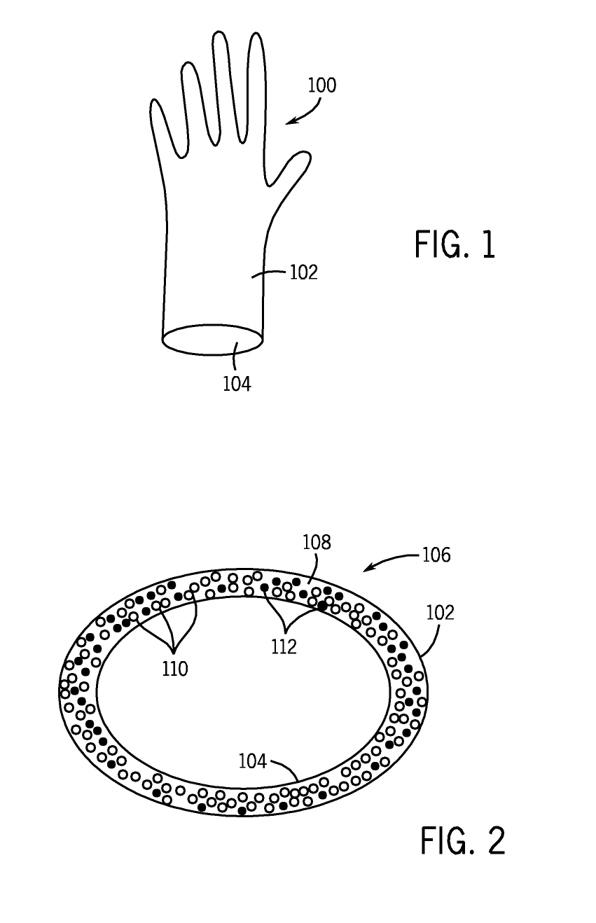

An exemplary elastomeric article, a glove 100, in accordance with the present invention, is illustrated in FIG. 1. The glove 100 includes an outside surface (distal surface or outer distal surface or outermost surface) (“OS”) 102 and an inside or wearer-contacting surface (“WCS”) 104. It will be appreciated by those skilled in the art, for purposes of the following discussion, the glove 100 may be a single layer glove, a bilaminar glove (two layers), and/or a multilayer glove wherein the exterior appearance of the glove 100 is substantially similar to that shown in FIG. 1, having an outside surface 102 and wearer-contacting surface 104.

Turning next to FIG. 2, a cross section of a glove 106 constructed of a single layer 108 of elastomeric material is illustrated. (It will be appreciated that the single layer glove 106 has an exterior appearance similar to glove 100 and has an outside surface 102 and a wearer-contacting surface 104).

The elastomeric material used to construct the layer 108 of the glove 106 comprises a polylacetic acid polymer component 110 and a plasticizer component 112. In particular, the layer 108 of elastomeric material used in the glove 106 includes from about 1% to about 100% polylacetic acid polymer component 110 and from 1% to about 100% plasticizer component 112. Preferably, the layer 108 of elastomeric material used in the glove 106 includes from about 1% to about 80% polylacetic acid polymer component 110 and from 1% to about 20% plasticizer component 112.

The polylacetic acid polymer component 110 preferably comprises from about 1% to about 100% L-lactide monomer, with the remaining monomer selected from, but not limited to, D-lactide, meso D,L lactide, D,L lactide monomers, and combinations thereof. Consistent with the broader aspects of the present invention, the polylacetic acid polymer component 110 can be any homopolymer of lacetic acid and/or a block, graft, random, copolymer, and/or a polyblend/elastomeric blend of lacetic acid, including, D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid. Suitable polylactide polymers can include, but are not limited to, those sold under the registered trademark NatureWorks from Cargill Dow or its licensees.

In particular, the particular weight percent of L-lactide, D-lactide, meso D,L Lactide, and/or D,L lactide monomer utilized in the glove 106 of the present invention can depend on the given end-use application of the gloves, e.g. the physical and/or permeability requirements of the gloves, the amount and/or type of plasticizer utilized and/or a specified degradation rate required for the gloves after disposal.

Indeed, as will be appreciated by those skilled in the art, a higher concentration of D-lactide monomer included within the polylacetic acid polymer component 110 can result in a polymer of greater crystallinity, yielding a higher tensile strength and lowering the elongation modulus of the final glove. As such, the concentration of a particular lactide monomer can be varied, as a matter of design choice, depending on the desired physical, chemical and/or degradation properties required for the glove application.

Without limitation, the biodegradable gloves of the present invention may be designed to have performance properties that meet or exceed those required for a petroleum based glove of similar use or function. For example, the gloves of the present invention preferably have a minimum film thickness of about 0.05 mm, a tensile strength of about 10 MPa, and an elongation at break of about 300% (reference is made to ASTM Standard D 5250-00^{•4}).

The polylacetic acid polymer component 110, and the ratio and/or types of lactide monomers utilized therein, are provided in a quantity sufficient to maintain or to not fall outside the physical requirements of the ASTM and ISO standards for the particular type of glove manufactured (such as, but not limited to all physical requirement tables, ASTM D 3577-01a^{•2}—Table 3, ASTM D 5250-00^{•4}—Table 3, ASTM D 6319-00a^{•3}—Table 3, ISO 11193:1994(E)—Table 3, ISO 10282: 1994(E)—Table 3, ASTM D 3578-01a^{•2}—Table 1, and ASTM D 4679-02— Table 3).

The plasticizer component 112 provided within the elastomeric material used to construct the layer 108 of the glove 106 can be any biodegradable plasticizer known to those skilled in the art capable of plasticizing the polylacetic acid polymer component 110. Such plasticizer components 112 preferably include, but are not limited to, citric acid esters, such as, triethyl citrate, acetyl triethyl citrate, and/or acetyl tributyl citrate.

Other biodegradable plasticizers may be used with good effect. Such plasticizers can include either substantially hydrophobic and/or substantially hydrophilic plasticizers, depending on the particular composition of the elastomer material, and include, but are not limited to, starch (corn, wheat, rice, potato, etc.), vegetable oils (soybean, linseed, etc.), sorbitol, glycerol, glycerin, glucose or sucrose ethers and esters, polyethylene glycol ethers and esters, low toxicity phthalates, alkyl phosphate esters, dialkylether diesters, tricarboxylic esters, epoxidized oils, epoxidized esters, polyesters, polyglycol diesters, alkyl, allyl ether diesters, aliphatic diesters, alkylether monoesters, dicarboxylic esters, and/or combinations thereof.

Further, plasticizers, in certain applications, can be selected to comply with the required industry, regulatory, and/or governmental standards, for example, those approved by the Food and Drug Administration for use in medical and/or examination gloves—as will be well known to those skilled in the art.

The plasticizer component 112 can be incorporated into the layer 108 of the glove 106 during, or after, polymerization of the polymer component. The plasticizer component 112 is provided in an amount sufficient to impart the desired physical requirements to the polylacetic acid polymer component 110 and/or to increase or decrease the polymer degradation rate. As such, addition of the plasticizer component 112 to the polylacetic acid polymer component 110 can also be used to control the operative degradation rate of the disposable gloves of the present invention.

In light of the foregoing, it will be readily appreciated by those skilled in the art that the elastomeric material including the biodegradable polylactide polymer component 110 and the plasticizer component 112 used in the glove 106 can be prepared as a compounded elastomer and may be an elastomer suspended into an emulsion, or an elastomer that is soluble or miscible in a solvent or plasticizer, and combinations thereof.

Further, consistent with the broader aspects of the present invention, the layer 108 may include additional components: 1. incorporated into the elastomeric material (including the polylacetic acid polymer component 110) from which the glove is made; and/or 2. coated on one or more surfaces of the glove 106. For example, a flavoring component, a detackifying agent, a donning enhancing agent, and/or a botanical component may be included in the elastomeric material from which the glove is made. For example, xylitol as described in more detail in U.S. patent application Ser. No. 11/138,193 entitled “Flavored Elastomeric Articles and Methods of Manufacturing Same”; Aloe extract and/or Nopal extract as described in more detail in U.S. patent application Ser. Nos. 10/373,970 and 10/373,985, entitled “Flexible Elastomer Articles and Methods of Manufacturing,” and in U.S. patent application Ser. No. 10/640,192, entitled “Gloves containing dry powdered aloe and method of manufacturing,” (each of which is assigned to the assignee of the present patent application and each of which is hereby incorporated herein by reference) may be included within the elastomeric matrix of the glove.

In addition, the layer 108 of the glove 106 may include one or more therapeutic components having one or more of the qualities of wound healing, anti-inflammatory properties, anti-microbial properties, analgesic properties, and anti-aging properties, as will also be appreciated by those skilled in the art. In addition, the layer 108 of the glove 106 may be colored and/or include a colorant within the elastomeric matrix from which it is formed. Such components are selected to be compatible with the polylacetic acid polymer component 110 and/or plasticizer component 112 and are provided in a quantity sufficient such that the glove 106 maintains or does not fall outside the ASTM and/or ISO standards required for the particular type of glove manufactured, as will also be well known to those skilled in the art.

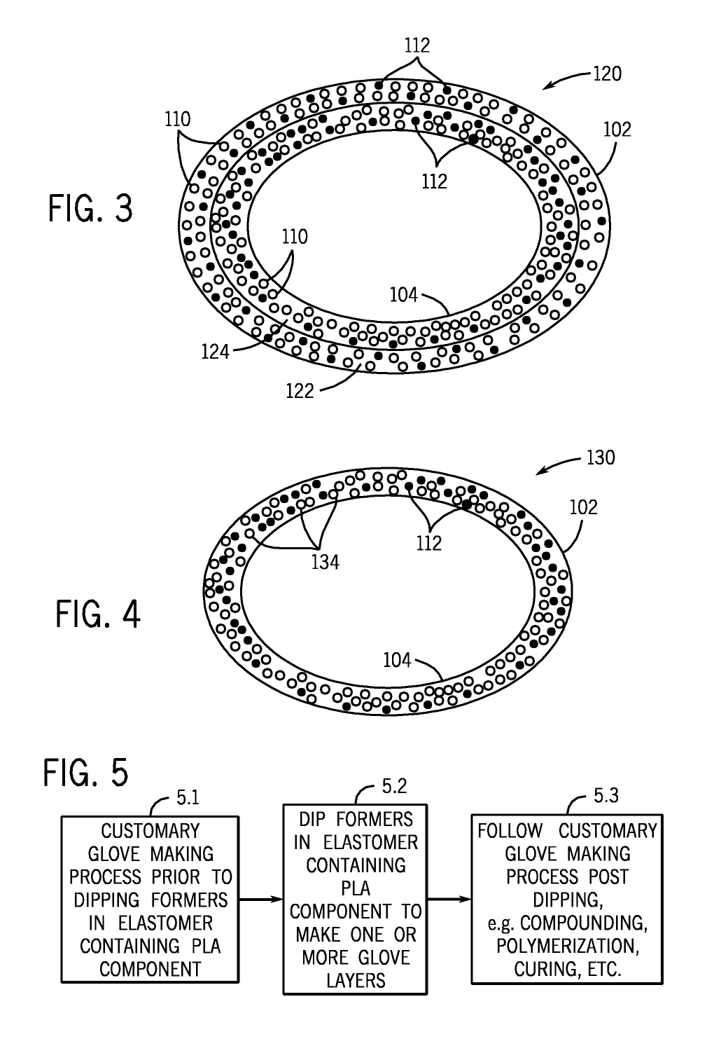

Referring next to FIG. 3, a cross section of a bilaminar glove 120 having a first layer 122 and a second layer 124 is shown. First layer 122 forms an exterior layer of the glove 120 and has an outside surface 102. The second layer 124 forms an interior layer of glove 120, having a wearer-contacting surface 104. It will be appreciated that the glove 120 has an exterior appearance similar to glove 100 (shown in FIG. 1).

The elastomeric material used for each of the first layer 122 and the second layer 124 of the bilaminar glove 120 comprises a polylacetic acid polymer component 110 and a plasticizer component 112. In particular, each of the layers 122 and 124 of elastomeric material used in the glove 120 includes from about 1% to about 100% polylacetic acid polymer component 110 and from about 1% to about 100% plasticizer component 112.

The polylacetic acid polymer component 110 can be any homopolymer of lacetic acid and/or a block, graft, random, copolymer, and/or polyblend of lacetic acid, including, D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid.

As recited with reference to the glove 106, the particular weight percent of D-lactide, L-lactide, meso D,L Lactide, and/or racemic D,L lactide monomer in each of the layers 122 and 124 can depend on the given end-use application of the gloves, e.g. the physical and/or permeability requirements of the gloves and/or the respective layers 122 and 124, the amount and/or type of plasticizer utilized within each of the layers 122 and 124, and/or a specified degradation rate required for the gloves after disposal.

The first layer 122 and the second layer 124 of the glove 120 may be made of a similar or a dissimilar polylacetic acid-based elastomeric materials, including each layer comprising a different combination and/or weight percent of D-lactide, L-lactide, meso D,L Lactide, and/or racemic D,L lactide monomer within the polylacetic acid polymer component 110 in each of the layers 122 and 124.

The plasticizer component 112 utilized within each of the layers 122 and 124 of the glove 120 is preferably a biodegradable plasticizer and includes any of those recited herein with respect to the glove 106. Accordingly, the plasticizer component 112 is preferably a citric acid ester, such as, triethyl citrate, acetyl triethyl citrate, and/or acetyl tributyl citrate.

The plasticizer component 112 can be incorporated into each of the layers 122 and 124 of the glove 120 during, or after, polymerization of the polymer component. As described with reference with the glove 106, the plasticizer component 112 is provided in an amount sufficient to impart the desired physical requirements to the polylacetic acid polymer component 110 and/or to increase or decrease the polymer degradation rate. Accordingly, addition of the plasticizer component 112 to the polylacetic acid polymer component 110 can also be used to control the operative degradation rate of the disposable gloves of the present invention—with such properties designed to be substantially similar in each of the layers 122 and 124, or each of the layers 122 and 124 of the glove 120 may be designed to have different properties. As such, the specific type of plasticizer component 112 used in each of the layers 122 or 124 may be similar or different, depending on the required properties of the glove 120.

As will be readily recognized by those skilled in the art, the gloves of the present invention can be constructed of any number of layers comprising one or more polylacetic acid polymer components and one or more biodegradable plasticizer components. In particular, the present invention encompasses gloves constructed of two or more layers of elastomeric material including about 1% to about 100% polylacetic acid polymer component and from 1% to about 100% biodegradable plasticizer component.

Accordingly, the polylacetic acid polymer component 110 used in each of the one or more layers of the gloves of the present invention may be made of similar or dissimilar elastomeric materials, including each layer having a different combination and/or weight percent of D-lactide, L-lactide, meso D,L Lactide, and/or D,L lactide monomer. Further, the biodegradable plasticizer component 112 can include any of those recited herein with respect to the gloves 106 and 120. As such, the plasticizer component 112 used in each of the layers 122 or 124 may be similar or different, depending on the required properties of the glove 120.

Turning next to FIG. 4, and consistent with the broader aspects of the present invention, a cross section of a glove 130 constructed of a single layer 132 of elastomeric material is illustrated. (It will be appreciated that the single layer glove 130 has an exterior appearance similar to glove 100 and has an outside surface 102 and a wearer-contacting surface 104.)

Preferably, the layer 132 of elastomeric material in the glove 130 comprises a biodegradable polymer component 134 and a biodegradable plasticizer component 112. In particular, the layer 132 of elastomeric material used in the glove 130 includes from about 1% to about 100% biodegradable polymer component 134 and from about 1% to about 100% plasticizer component 112.

The biodegradable polymer component 134 is preferably a polylacetic acid-based polymer comprising from about 1% to about 100% a homopolymer of lacetic acid and/or from about 1% to about 100% a block, graft, random, copolymer, and/or polyblend of lacetic acid, including, D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid.

The biodegradable polymer component 134 may further comprise any substantially biodegradable and/or compostable polymer component including, but not limited to, homopolymers, block, graft, random, copolymer, and/or polyblends of polyglycolic acid, polycaprplactone, polyhydroxybutyrate, aliphatic polyesters, polyalkylene esters, polyester amides, polyvinyl esters, polyester carbonates, polyvinyl alcohols, polyanhydrides, polysaccharides such as starch and combinations thereof, as will be well known to those skilled in the art.

In particular, the particular weight percent of polylacetic acid-based polymer in the biodegradable polymer component 134 utilized in the glove 106 of the present invention can be depend on the given end-use application of the gloves, e.g. the physical and/or permeability requirements of the gloves, the amount and/or type of plasticizer utilized, and/or a specified degradation rate required for the gloves after disposal.

Preferably, the weight percent of the polylacetic acid-based polymer is greater than about 75% of the biodegradable polymer component 134 and is provided in a quantity sufficient to maintain, and to not fall outside the physical requirements of the ASTM and ISO standards for the particular type of glove manufactured (such as, but not limited to all physical requirement tables, ASTM D 3577-01a^{•2}—Table 3, ASTM D 5250-00^{•4}—Table 3, ASTM D 6319-00a^{•3}—Table 3, ISO 11193:1994(E)—Table 3, ISO 10282: 1994(E)—Table 3, ASTM D 3578-01a^{•2}—Table 1, and ASTM D 4679-02—Table 3).

The plasticizer component 112 utilized in the glove 130 is preferably biodegradable and includes any one or more of those biodegradable plasticizers described herein or known to those skilled in the art capable of plasticizing the biodegradable polymer component 134. Such plasticizer components preferably include, but are not limited to, citric acid esters, such as, triethyl citrate, acetyl triethyl citrate, and/or acetyl tributyl citrate.

Consistent with the broader aspects of the present invention, and where required by a given end-use application for the glove or specified physical properties required for the glove, the layer 132 of elastomeric material in the glove 130 can comprise a nonbiodegradable and/or substantially nonbiodegradable polymer component, such as polyvinylchloride, in combination with the biodegradable polymer component 134 and the plasticizer component 112. Indeed, a polylactide polymer component and biodegradable plasticizer component can be used to modify or otherwise alter the degradation properties of a petroleum-based polymer—the resulting glove being substantially biodegradable compared to a glove manufactured of the petroleum-based polymer alone.

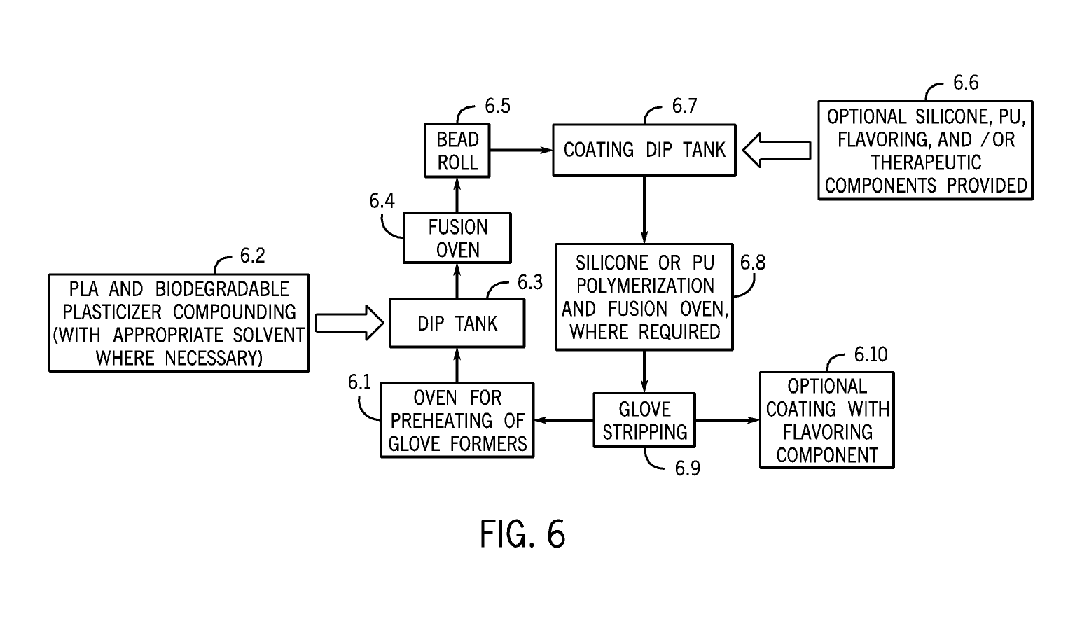

As best shown in FIG. 5, the present invention also comprehends the method of making a biodegradable, disposable glove having one or more layers constructed of a polylacetic acid (PLA) polymer component and a biodegradable plasticizer component. As will be understood, the polylacetic acid (PLA) polymer component and the biodegradable plasticizer component used in the methods described with reference to FIGS. 5 and 6 can be any one or more of those described with reference with the gloves 106, 120, and 130.

Turning next to FIG. 5, a general method of making the biodegradable, disposable gloves of the present invention is disclosed. In Step 5.1, the process of glove making of the present invention utilizes customary glove making procedures prior to dipping the formers into the elastomeric material containing the polylacetic acid polymer component 110 and the plasticizer component 112. In Step 5.2, the formers are dipped into the elastomeric material including the polylacetic acid polymer component 110 and the plasticizer component 112. The composition of the elastomeric material can be any of those disclosed supra.

In Step 5.3, the formers are processed according to usual glove making techniques, e.g. polymerization, compounding, curing, fusing, solvent evaporation, etc. to form a biodegradable, polylacetic acid glove. The general process of FIG. 5, may be used for making single layer gloves, bilaminar gloves, and multilayer gloves.

As will be well known to those skilled in the art, the methods of making gloves of the present invention can utilize any general prior art glove making methods known to those skilled in the art—using an elastomeric material comprising a polylacetic acid polymer. (see again, U.S. patent application Ser. Nos. 10/373,970 and 10/373,985, entitled “Flexible elastomer articles and methods of manufacturing”, and in U.S. patent application Ser. No. 10/640,192, entitled “Gloves Containing Dry Powdered Aloe and Method of Manufacturing”). Accordingly, the biodegradable, polylacetic acid gloves of the present invention can be manufactured by any method known by those skilled in the art with merely a slight modification to existing processes.

For example, FIG. 6 discloses a dipping operation for manufacturing a biodegradable, polylactide glove of the present invention, wherein the elastomeric material of the glove includes one or more polylacetic acid polymer components and one or more biodegradable plasticizer components of the type disclosed with reference to the gloves 106, 120 and/or 130 described herein.

In Step 6.1, an oven is prepared for pre-heating glove formers. In Step 6.2, the polylacetic acid polymer component and the biodegradable plasticizer component are compounded (in the presence of an appropriate solvent, e.g. methylene chloride or tetrahydrofuran (THF), where required) and poured into a dip tank. Step 6.2 may also include the additional of optional components, such as colorants, as will be well known to those skilled in the art. In Step 6.3, the dip tank accepts the glove formers and the glove formers are coated with the elastomeric material including the polylacetic acid polymer and the biodegradable plasticizer component. In Step 6.4, the glove formers, with the coating of the elastomeric material, enter a fusion oven. In Step 6.5, a bead roll cuff is applied to the fused elastomeric material.

In Step 6.6, optional silicone, polyurethane, flavoring, botanical, and/or therapeutic component can be provided. In Step 6.7, the glove formers are dipped into the dip tank containing such optional components. In Step 6.8, the silicone or polyurethane, where provided, are polymerized on the surface of the elastomeric material including the polylacetic acid polymer and the biodegradable plasticizer component during fusion of the elastomeric material. After fusion, in Step 6.9 the biodegradable, polylactide gloves are stripped from the glove formers. Alternatively, in Step 6.10, the gloves are then optionally coated with one or more optional components such as a flavoring component, according to the previously discussed methods of coating gloves.

Accordingly, it will be readily apparent to those skilled in the art that the methods depicted in FIGS. 5 and 6 can also include incorporation of one or more colorants, flavoring, botanical, therapeutic, quality control/processing compositions into the elastomeric matrix containing the polylacetic acid polymer component. It will also be readily apparent that the biodegradable, disposable polylactide gloves of the present invention may also be coated with one or more flavoring, botanical, therapeutic, quality control/processing compositions. Such coating materials can include, but are not limited to, xylitol, Aloe, Nopal, Vitamin E, Vitamin A, Vitamin C, Vitamin B₃, Vitamin B₅, jojoba, rose hip, tea tree oil, flax seed oil, palm oil, and/or acetylsalicylic acid.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A substantially biodegradable glove comprising at least one layer of an elastomeric material including a polylacetic acid polymer component and a biodegradable plasticizer component.

2. A substantially biodegradable glove as defined in claim 1, wherein the polylacetic acid polymer component comprises D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid.

3. A substantially biodegradable glove as defined in claim 2, wherein the polylacetic acid polymer component comprises from about 1% to about 100% L-polylacetic acid.

4. A substantially biodegradable glove as defined in claim 1, wherein the biodegradable plasticizer component is a citric acid ester.

5. A substantially biodegradable glove as defined in claim 4, wherein the citric acid ester is selected from the group consisting of triethyl citrate, acetyl triethyl citrate, acetyl tributyl citrate, and combinations thereof.

6. A substantially biodegradable glove as defined in claim 1, wherein the at least one layer of elastomeric material further comprises a biodegradable polymer resin selected from the group consisting of homopolymers, block, graft, random, copolymer and polyblends of polyglycolic acid, polycaprplactone, polyhydroxybutyrate, aliphatic polyesters, polyalkylene esters, polyester amides, polyvinyl esters, polyester carbonates, polyvinyl alcohols, polyanhydrides, polysaccharides, and combinations thereof.

7. A substantially biodegradable glove as defined in claim 1, further comprising at least one of a flavoring component, an antimicrobial agent, a detackifying agent, a botanical extract, a donning enhancing agent, a colorant component, and a therapeutic component incorporated into the elastomeric material.

8. A substantially biodegradable glove as defined in claim 1, wherein the glove comprises a plurality of layers of an elastomeric material, each of the layers of the elastomeric material having an elastomeric matrix comprising a polylacetic acid polymer component and a biodegradable plasticizer component.

9. A substantially biodegradable glove as defined in claim 1, wherein the glove is a medical glove.

10. A flexible, elastomeric disposable glove comprising at least one layer of an elastomeric material forming an elastomeric matrix, the elastomeric matrix comprising a polylacetic acid polymer component in combination with a biodegradable plasticizer component.

11. A disposable glove as defined in claim 10, wherein the elastomeric matrix comprises from about 1% to about 99% the polylacetic acid polymer component.

12. A disposable glove as defined in claim 10, wherein the elastomeric matrix comprises up to about 20% biodegradable plasticizer component.

13. A disposable glove as defined in claim 10, wherein the polylacetic acid polymer component comprises D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid.

14. A disposable glove as defined in claim 10, wherein the biodegradable plasticizer component is a citric acid ester or combinations thereof.

15. A disposable glove as defined in claim 10, wherein the glove comprises a plurality of layers of an elastomeric material, each of the layers of the elastomeric material having an elastomeric matrix comprising a polylacetic acid polymer component and a biodegradable plasticizer component.

16. A glove comprising:
one or more layers of an elastomeric material, the one or more layers including a wearer-contacting surface and a distal surface, wherein at least one of the one or more layers of elastomeric material comprises:
a polylacetic acid polymer component selected from the group consisting of D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid; and
a biodegradable plasticizer component selected from the group consisting of citric acid esters and combinations thereof.

17. A glove as defined in claim 16, wherein the citric acid ester is selected from the group consisting of triethyl citrate, acetyl triethyl citrate, acetyl tributyl citrate, and combinations thereof.

18. A glove as defined in claim 16, wherein at least one of the one or more layers of elastomeric material comprises further comprises a biodegradable polymer resin selected from the group consisting of homopolymers, block, graft, random, copolymer and polyblends of polyglycolic acid, polycaprplactone, polyhydroxybutyrate, aliphatic polyesters, polyalkylene esters, polyester amides, polyvinyl esters, polyester carbonates, polyvinyl alcohols, polyanhydrides, polysaccharides, and combinations thereof.

19. A glove as defined in claim 16, further comprising at least one of a flavoring component, an antimicrobial agent, a detackifying agent, a botanical extract, a donning enhancing agent, a colorant component, and a therapeutic component incorporated into the elastomeric material.

20. A glove as defined in claim 16, further comprising at least one of a flavoring component, an antimicrobial agent, a detackifying agent, a botanical extract, a donning enhancing agent, a colorant component, and a therapeutic component applied to at least one of the wearer-contacting surface and the distal surface.

21. A glove as defined in claim 16, wherein the glove comprises a plurality of layers of an elastomeric material and wherein each layer of the one or more layers of elastomeric material comprises:
a polylacetic acid polymer component selected from the group consisting of D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid; and
a biodegradable plasticizer component selected from the group consisting of citric acid esters and combinations thereof.

22. A glove comprising at least one layer of an elastomeric material consisting essentially of a polylacetic acid polymer component and a biodegradable plasticizer component.

23. A glove as defined in claim 22, wherein the polylacetic acid polymer component consists essentially of D-polylacetic acid, L-polylacetic acid, D,L-polylacetic acid, meso-polylacetic acid, and any combination of D-polylacetic acid, L-polylacetic acid, D,L-polylacetic acid, and meso-polylacetic acid.

24. A glove as defined in claim 22, wherein the biodegradable plasticizer component is selected from the group consisting of triethyl citrate, acetyl triethyl citrate, acetyl tributyl citrate, and combinations thereof.

25. A glove as defined in claim 22, wherein the glove comprises a plurality of layers of an elastomeric material, wherein each of the layers comprises an elastomeric material consisting essentially of a polylacetic acid polymer component and a biodegradable plasticizer component.
